(19) United States
(12) Patent Application Publication
(10) Pub. No.: US 2021/0288577 A1
(43) Pub. Date: Sep. 16, 2021

(54) AUXILIARY POWER SUPPLY CIRCUIT AND POWER SUPPLY DEVICE

(71) Applicant: SHARP KABUSHIKI KAISHA, Sakai City (JP)

(72) Inventor: TAKESHI SHIOMI, Sakai City (JP)

(21) Appl. No.: 17/192,721

(22) Filed: Mar. 4, 2021

(30) Foreign Application Priority Data
Mar. 13, 2020 (JP) 2020-044289

(51) Int. Cl. H02M 3/155

(52) U.S. Cl. CPC H02M 3/155; H02M 1/42

(57) ABSTRACT

An auxiliary power supply circuit configured to receive power from an auxiliary power supply in which a negative electrode is connected to a switch node; and supply power to a capacitor in which a negative electrode is connected to a high potential node, the auxiliary power supply circuit comprises a switch element connected between the high potential node and the switch node; and a diode in which an anode is connected to a positive electrode of the auxiliary power supply and a cathode is connected to a positive electrode of the capacitor, wherein a voltage at the switch node is alternately switched to (i) a first voltage that is substantially the same as a voltage at the high potential node, and (ii) a second voltage that is lower than the first voltage.

### CROSS-REFERENCE TO RELATED APPLICATION

The present application claims priority from Japanese Application JP2020-044289, the content of which is hereby incorporated by reference into this application.

### BACKGROUND OF THE INVENTION

### 1. Field of the Invention

The following disclosure relates to an auxiliary power supply circuit.

### BACKGROUND ART

The auxiliary power supply circuit provides an auxiliary power supply that assists the circuit operation. Miniaturization is also important for auxiliary power supply circuits. JP 2015-154632 A discloses a bootstrap circuit for the purpose of miniaturizing the auxiliary power supply circuit.

### SUMMARY OF THE INVENTION

However, the known miniaturized auxiliary power supply circuit cannot supply the auxiliary power supply to a high potential node. An object of one aspect of the present disclosure is to provide an auxiliary power supply circuit capable of supplying an auxiliary power supply to a high potential node.

In order to solve the above-described problem, an auxiliary power supply circuit according to one aspect of the present disclosure receives power from an auxiliary power supply in which a negative electrode is connected to a switch node, and supplies power to a capacitor in which a negative electrode is connected to a high potential node. The auxiliary power supply circuit includes a switch element connected between the high potential node and the switch node, and a diode in which an anode is connected to a positive electrode of the auxiliary power supply and a cathode is connected to a positive electrode of the capacitor. A voltage at the switch node is alternately switched to (i) a first voltage that is substantially the same as a voltage at the high potential node, and (ii) a second voltage that is lower than the first voltage.

According to one aspect of the present disclosure, it is possible to provide an auxiliary power supply circuit capable of supplying an auxiliary power supply to a high potential node.

### BRIEF DESCRIPTION OF THE DRAWINGS

FIG. 1 is a diagram illustrating a circuit configuration of a power supply circuit according to a first embodiment.

FIG. 2 is a diagram showing each voltage and current waveform in an auxiliary power supply circuit.

FIG. 3 is a diagram illustrating current paths in the auxiliary power supply circuit.

FIG. 4 is a diagram illustrating a circuit configuration of a power supply circuit according to a second embodiment.

FIG. 5 is a diagram illustrating a power supply device according to a third embodiment.

### DETAILED DESCRIPTION OF THE INVENTION

### First Embodiment

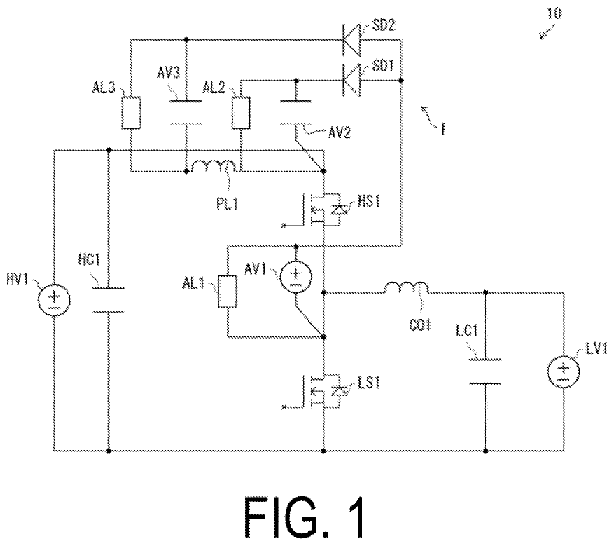

An auxiliary power supply circuit 1 and a power supply circuit 10 of a first embodiment will be described below with reference to FIG. 1. Note that, for convenience of description, in each embodiment hereinafter, components having the same functions as those of components described in the first embodiment are denoted using the same reference numerals, and descriptions thereof will not be repeated. For the sake of brevity, “power supply HV1” is also simply referred to as “HV1”, for example. Also, note that each numerical value described below is merely an example.

### Definitions of Terms

Prior to describing the auxiliary power supply circuit 1, each term is defined in the present specification as follows.

“Power supply circuit”: A circuit that coverts power from a power supply on an input side to a power supply on an output side. As an example, a circuit that converts power from an AC230V power supply to a DC400V power supply. The power conversion includes, for example, a known AC-DC conversion or an AC frequency conversion.

“Power supply device”: A device provided with a power supply circuit.

“Power supply”: Energy (electric power) outputted from a power supply circuit or a power supply device. Strictly speaking, the power supply is not a circuit element, but is expressed using a power supply symbol on a circuit diagram.

“Auxiliary power supply circuit”: An auxiliary power supply circuit provided in a circuit for operating a power supply circuit or a power supply device.

“Auxiliary power supply”: Energy (electric power) outputted from an auxiliary power supply circuit. Strictly speaking, the auxiliary power supply is not a circuit element, but is expressed using a power supply symbol or a capacitor symbol on a circuit diagram.

“Rectifying element”: An element that allows current to flow in only one direction. A diode can be mentioned as an example of the rectifying element. A transistor can be mentioned as another example of the rectifying element. In more detail, in a case where the rectifying element is a transistor, when a gate is off, the rectifying element causes a current to flow from a source to a drain and cuts off the current from the drain to the source. Accordingly, in the other example, (i) the source can be considered an anode, and (ii) the drain can be considered a cathode, by replacing each.

“Transistor element”: An element that switches whether or not a current flows from a drain to a source by turning on/off a gate of a metal oxide semiconductor field effect transistor (MOSFET). Note that in a case where the element is a bipolar transistor, an insulated gate bipolar transistor (IGBT), or the like, (i) the drain can be considered a collector, and (ii) the source can be considered an emitter.

“Switch element”: An element capable of changing voltage of any node (e.g., switch node). Examples of switch element include a rectifying element, a transistor element, and a magnetic element (e.g., transformer winding and coil).

Overview of Configuration of Power Supply Circuit 10

The power supply circuit 10 is a bidirectional DC/DC converter that can bidirectionally transmit electric power between a high-voltage power supply and a low-voltage power supply. The power supply circuit 10 is provided with (i) the auxiliary power supply circuit 1, and (ii) a load used for a test in which the power of the auxiliary power supply is consumed. The load is a circuit element for confirming the operation of the auxiliary power supply, and is replaced with a circuit that is not particularly determined when the power supply circuit 10 is actually used.

Configuration of High-Voltage Portion of Power Supply Circuit 10

A high-voltage portion is provided with a power supply HV1 and a capacitor HCl. The (+) side of the power supply symbols indicates a positive electrode side, and the (−) side indicates a negative electrode side. HV1 has a voltage of 0 V on the negative electrode side, and a voltage of 400 V on the positive electrode side. The electrostatic capacitance of HCl is 1 mF.

In the first embodiment, 0 V is set as a reference potential. The node of 0 V is referred to as a reference potential node. Further, a potential higher than the reference potential is referred to as a high potential. Then, the node having the high potential is referred to as a high potential node. The high potential in the present specification is, for example, a voltage of 10 V to 1200 V. The 400 V node is an example of the high potential node.

Configuration of Low-Voltage Portion of Power Supply Circuit 10

A low-voltage portion is provided with a power supply LV1, a capacitor LC1, and a coil CO1. The voltage of LV1 is 200 V. The electrostatic capacitance of LC1 is 1 mF. The inductance of CO1 is 1 mH and the average current of CO1 is 12 A. The voltage of LV1 is designed to be one half the voltage of HV1.

Configuration of Switch Portion of Power Supply Circuit 10

A switch portion has a half-bridge structure by a switch element HS1 and a switch element LS1. One end of CO1 is 6) connected to a switch node, which is a connection point between HS1 and LS1. The voltage at the switch node is switched to a first voltage and a second voltage alternately at a frequency of 100 kHz by switching HS1 or LS1.

The first voltage is substantially the same voltage as the voltage of the high potential node (400 V). The second voltage is a voltage lower than the first voltage. In the example of the first embodiment, the second voltage is approximately 0 V.

The first voltage in the present specification means a voltage within ±5 V with respect to the voltage of the high potential node. In the example of the first embodiment, the first voltage is a voltage in the range of 395 V or more and 405 V or less. The range of the first voltage depends on a voltage drop amount of HS1.

Both HS1 and LS1 are cascode GaN-HEMTs with a drain withstand voltage of 650 V and an on-resistance of 50 mΩ. In the example of FIG. 1, the circuit symbol of the MOSFET is used to represent the cascode GaN-HEMT.

Configuration 1 of Auxiliary Power Supply Circuit 1 of Power Supply Circuit 10

The auxiliary power supply circuit 1 includes HS1, an auxiliary power supply AV1, an auxiliary power supply AV2 (also referred to as a capacitor in the first embodiment), and a diode SD1.

The auxiliary power supply circuit 1 is configured to receive power from AV1 in which a negative electrode is connected to the switch node. Further, the auxiliary power supply circuit 1 is configured to supply power to AV2 in which a negative electrode is connected to a high potential node. In the example of FIG. 1, the upper terminal of AV2 is the positive electrode of AV2. In this manner, the auxiliary power supply circuit 1 supplies an auxiliary power supply from the switch node to the high potential node.

HS1 is connected between the high potential node and the switch node. An anode of SD1 is connected to the positive electrode of AV1. Also, a cathode of SD1 is connected to the positive electrode of AV2.

AV1 is an auxiliary power supply outputted from a flyback circuit (not illustrated) using an isolation transformer. AV1 is an auxiliary power supply of 15 V with reference to the switch node. AV2 is an auxiliary power supply of 15 V with reference to the high potential node. The electrostatic capacitance of AV2 is 100 μF. A forward voltage (VF) at the start of the conduction of SD1 is 0.7 V. The resistance of SD1 in a conducting state is 0.1 n.

Configuration 2 of Auxiliary Power Supply Circuit 1 of Power Supply Circuit 10

In addition to AV2 and SD1, the auxiliary power supply circuit 1 further includes an auxiliary power supply AV3 (also referred to as a capacitor in the first embodiment) and a diode SD2.

The auxiliary power supply circuit 1 is configured to supply power to AV3 in addition to supplying power to AV2.

AV3 is an auxiliary power supply of 15 V with reference to the high potential node. In the example of FIG. 1, the upper terminal of AV3 is the positive electrode of AV3. The electrostatic capacitance of AV3 is 1 μF. SD2 is an element having the same specification as SD1.

Further, a coil PL1 (inductance 1 μH) is provided in a charging path for AV3 (described later). PL1 is a circuit element connected for circuit stability evaluation. PL1 is not a circuit element necessary for the operation of the auxiliary power supply circuit 1.

In the first embodiment, load resistors AL1 to AL3 are connected in order to demonstrate the operation of the auxiliary power supply circuit 1. AL1 is connected in parallel with AV1. AL2 is connected in parallel with AV2. The respective resistance values of AL1 and AL2 are 7.5Ω. AL3 is connected in parallel with AV3. The resistance value of AL3 is 750Ω.

Description of Operation of Power Supply Circuit 10

The power supply circuit 10 operates in the same manner as a general bidirectional DC/DC converter. The step-up operation of the power supply circuit 10 is as follows. In the following description, it is assumed that HS1 is turned off in advance.

(1) First, by turning on LS1, a current flows from the positive electrode of LV1 to the negative electrode of LV1 through CO1 and LS1. At this time, the voltage at the switch node drops to approximately 0 V (second voltage).

(2) Next, by switching LS1 off, a current flows from the positive electrode of LV1 to the negative electrode of LV1 through CO1, HS1, and HV1. At this time, the voltage at the switch node rises to the voltage of the high potential node (first voltage).

In the step-up operation, the above-described (1) and (2) are repeated in sequence.

On the other hand, in the step-down operation of the power supply circuit 10, a current is passed from HV1 to LV1 by switching HS1 on/off. Also in the step-down operation, as in the case of the step-up operation described above, the voltage at the switch node is alternately switched to the first voltage and the second voltage.

Description of Operation of Auxiliary Power Supply Circuit 1

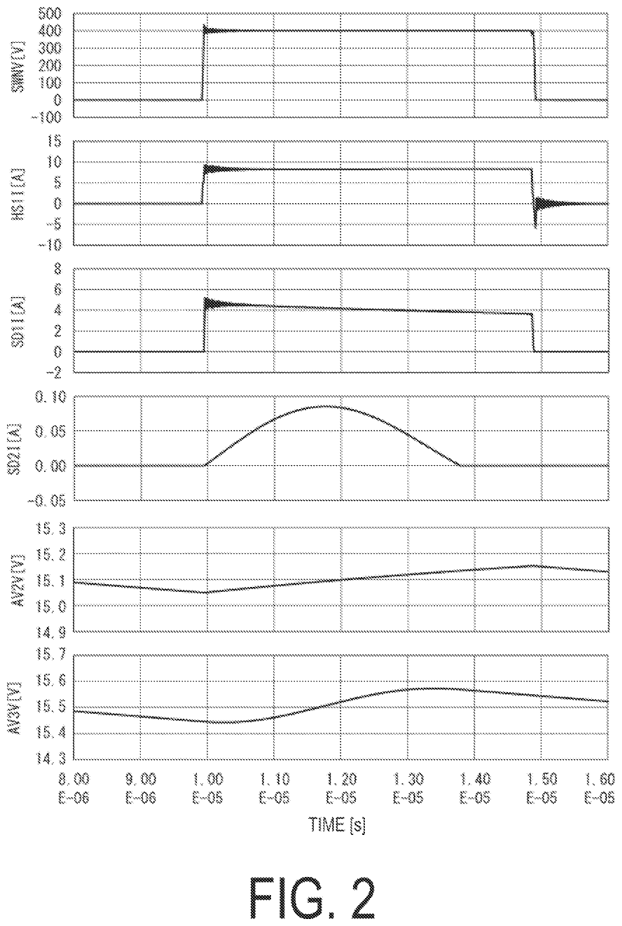

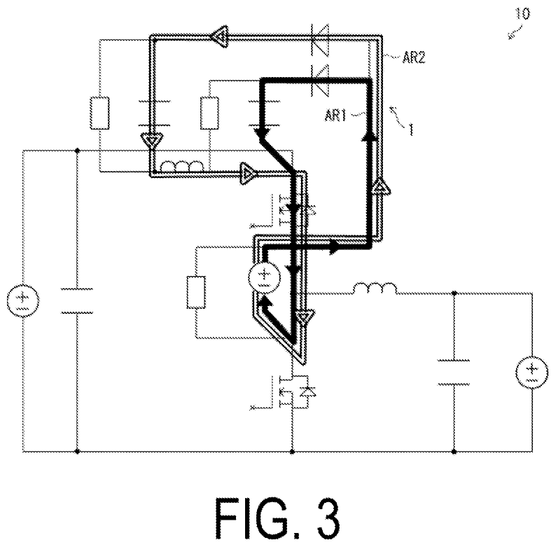

The operation of the auxiliary power supply circuit 1 will be described with reference to FIGS. 2 and 3. FIG. 2 is a graph showing a voltage and current waveform of each portion in the auxiliary power supply circuit 1. These waveforms are shown based on a common time axis (horizontal axis). Each waveform is as follows.
SWNV (Switch node voltage): The switch node voltage with respect to the reference potential;
HS1I (HS1 current): The current flowing from the switch node to the high potential node;
SD1I (SD1 current): The current flowing from the anode to the cathode;
SD2I (SD2 current): The current flowing from the anode to the cathode;
AV2V (AV2 voltage): The voltage of the positive electrode with reference to the negative electrode; and
AV3V (AV3 voltage): The voltage of the positive electrode with reference to the negative electrode.

In FIG. 3, the same circuit diagram as in FIG. 1 is illustrated, but the reference numerals used in FIG. 1 are omitted as appropriate. In FIG. 3, the current paths when charging AV2 and AV3 are indicated by arrows.

Drive Method of Auxiliary Power Supply Circuit 1

In a drive method of the auxiliary power supply circuit 1, the following three steps are executed in this order.
First step: A step of raising SWNV to the first voltage;
Second step: A step of flowing SD1I to charge AV2; and
Third step: A step of lowering SWNV to the second voltage.

First Step: Raising SWNV

Prior to the first step, by turning off HS1, a source-drain voltage of HS1 becomes approximately 400 V (SWNV becomes approximately 0 V). In this state, a rectified current is passed through HS1 to make HS1 conductive. That is, HS1 is turned on. Accordingly, SWNV rises to 400 V and becomes the first voltage. The point in time “approximately 1.00×10⁻⁵ sec” in FIG. 2 is the timing at which the SWNV shifts to the first voltage. From this point in time, the voltages at the negative electrodes of AV1 and AV2 are both approximately 400 V.

Second Step: Flowing SD1I to Charge AV2

Following the rise in SWNV, SD1I flows to charge AV2. This is established by the following factors.

AV2 is a capacitor. Thus, the voltage of AV2 decreases with the energy consumption of AL2. On the other hand, AV1 is an output power supply of the auxiliary power supply circuit using an isolation transformer. Thus, the voltage drop of AV1 does not occur. As a result, the voltage of AV2 becomes smaller than the voltage of AV1.

Accordingly, when the voltages of the negative electrodes of AV1 and AV2 become the same potential, a current flows from AV1 to AV2 having a smaller voltage. A solid arrow AR1 in FIG. 3 corresponds to this current path. Since this current flows through SD1, the charging in AV2 can be determined by measuring SD1I.

It can be confirmed that SD1I is flowing in the period “approximately 1.00×10⁻⁵ to 1.50×10⁻⁵ sec” in FIG. 2. In addition, in this period, it can be confirmed that AV2V is charged from 15.05 V to 15.15 V.

Third Step: Lowering SWNV to Predetermined Voltage

After charging AV2, SWNV is set to approximately 0 V. In the first embodiment, the parasitic capacitance of HS1 is charged and the SWNV is set to the second voltage. Accordingly, the potential difference between the negative electrodes of AV1 and AV2 is approximately 400 V. Therefore, SD1I does not flow from the positive electrode of AV1 (approximately 15 V) to the positive electrode of AV2 (415 V). That is, the charging in AV2 is temporarily stopped.

Charging in AV3

The auxiliary power supply circuit 1 includes AV3 in addition to AV2. SD2 is used for charging AV3. The charging in AV3 can be confirmed by measuring SD2I. The charging path for AV3 is a double arrow AR2 in FIG. 3.

In the auxiliary power supply circuit 1, a plurality of auxiliary power supplies can be created by simply adding a diode and a capacitor. Further, even when a parasitic inductance corresponding to PL1 exists in the auxiliary power supply circuit 1, there is no particular problem.

Improvements 1 to 3 for Operating Auxiliary Power Supply Circuit 1

In the first embodiment, a plurality of preferred improvements are applied. These preferred improvements will be described below.

Improvement 1: Voltage of AV1 is Smaller than First Voltage

In the example of the first embodiment, the first voltage is approximately 400 V. On the other hand, the voltage of AV1 is 15 V, which is smaller than 400 V.

When the voltage of AV1 is larger than the first voltage (e.g., when the voltage of AV1 is 450 V), a high voltage may be applied to HS1. Specifically, when AV1 is activated while the power supply circuit 10 is inactive, the parasitic capacitance of HS1 is charged via SD1 and a voltage of 450 V is applied to HS1. The charging path for the parasitic capacitance is AR1 in FIG. 3.

Originally, the voltage to be applied to HS1 is assumed to be 400 V. Accordingly, HS1 may be damaged due to the overvoltage. Thus, it is preferred that the voltage of AV1 be smaller than the first voltage.

Improvement 2: Parasitic Capacitance of SD1 is 1/20 or Less of Electrostatic Capacitance of AV2

In the example of the first embodiment, the parasitic capacitance of SD1 is 30 pF. When the switch node voltage rises, a reverse voltage is applied to SD1. At this time, a current that charges the parasitic capacitance of 30 pF flows from the positive electrode of AV2 to the positive electrode of AV1. Since the voltage of AV2 will decrease, it is preferable to set the parasitic capacitance of SD1 to be small.

In the first embodiment, the parasitic capacitance of SD1 is set to 5% ( 1/20) of the electrostatic capacitance of AV2 or less. By setting the parasitic capacitance of SD1 in this manner, a rate of decrease in the voltage of AV2 due to the discharge can be reduced to within approximately 5. (within a range that can be regarded as an error).

Improvement 3: When Current Flows from Switch Node to High Potential Node Via HS1, Current Flows from Positive Electrode of AV1 to Positive Electrode of AV2 Via SD1

When HS1 causes a rectified current to flow to the high potential node, a conduction loss occurs in HS1. On the other hand, the direction of the charging current (SD1I) for AV2 is opposite to the direction of the rectified current at the position of HS1. Thus, the current flowing through HS1 is offset by SD1I. As a result, the conduction loss of HS1 is reduced.

The HS1I after this offset can be confirmed in the period “approximately 1.00×10⁻⁵ to 1.50×10⁻⁵ sec” in FIG. 2. It can be confirmed that the value of current (current of CO1), which should normally flow 12A, is reduced by approximately 4 A (approximately 8 A). That is, the charging current for AV2 (4 A as SD1I) reduces HS1I by approximately 4 A.

### Second Embodiment

The auxiliary power supply circuit 1 according to one aspect of the present disclosure can also be used for reducing the switching loss to be generated in HS1 or LS1. Specifically, the switching loss is reduced by reducing the transient current generated at switching. The transient current here means, for example, a recovery current or a charging current for parasitic capacitance.

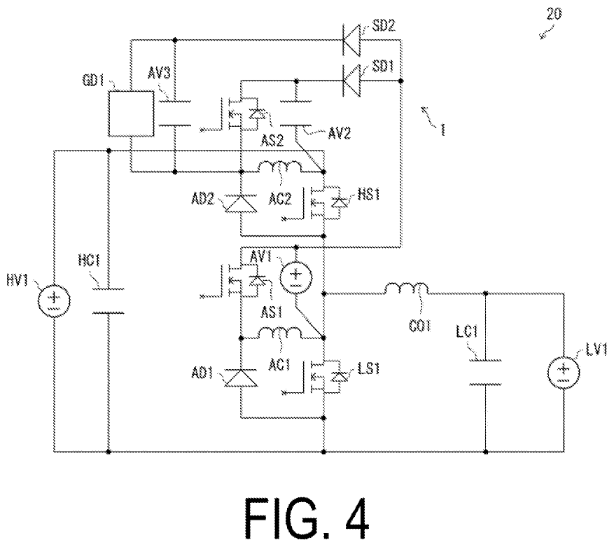

A power supply circuit 20 in FIG. 4 is a bidirectional DC/DC converter like the power supply circuit 10. In the power supply circuit 20, AL1 and AL2 are replaced with circuits for reducing transient currents to be generated in HS1 and LS1 with respect to the power supply circuit 10.

The circuit for reducing the transient current for HS1 will be described. An auxiliary switch AS2, an auxiliary coil AC2, and an auxiliary diode AD2 added around AV2 can reduce the transient current generated in HS1. The reduction method is as follows. First, by turning on AS2 before the transient current flows, the energy of AV2 is passed through AC2 and converted into magnetic energy. Thereafter, by turning off AS2, the magnetic energy is converted into a current passing through AD2 and passed through HS1. As a result, the transient current can be reduced by the amount of the current flowing through AD2.

Also for LS1, a circuit for reducing a transient current similar to the example of HS1 is configured. An auxiliary switch AS1, an auxiliary coil AC1, an auxiliary diode AD1 added around AV1 configure the transient current reduction circuit for LS1. The method for reducing the transient current is similar to the example of HS1.

In the power supply circuit 20, AL3 of the power supply circuit 10 is replaced with a gate driving circuit GD1. GD1 drives a gate of AS2.

### Third Embodiment

The power supply circuit 10 according to one aspect of the present disclosure can be applied to an inverter circuit, a totem pole power factor correction (PFC) circuit, and the like, in addition to the bidirectional DC/DC converter.

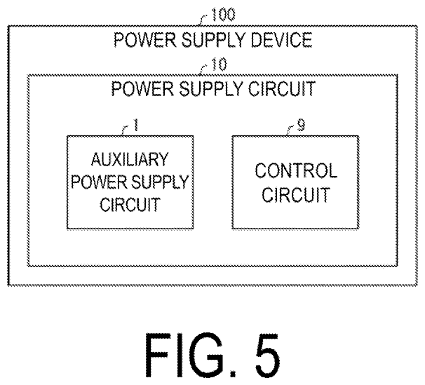

FIG. 5 is a diagram illustrating a power supply device 100 provided with the power supply circuit 10. According to the auxiliary power supply circuit 1, an auxiliary power supply with reference to a high potential node can be provided to the power supply circuit 10 and the power supply device 100. Furthermore, the power supply circuit 10 includes the control circuit 9. The control circuit 9 controls the ON/OFF switching of the elements provided in the power supply circuit 10. In particular, the control circuit 9 controls ON/OFF switching of HS1 and LS1.

Supplement

An auxiliary power supply circuit according to a first aspect of the present disclosure receives power from an auxiliary power supply in which a negative electrode is connected to a switch node, and supplies power to a capacitor in which a negative electrode is connected to a high potential node. The auxiliary power supply circuit includes a switch element connected between the high potential node and the switch node, and a diode in which an anode is connected to a positive electrode of the auxiliary power supply and a cathode is connected to a positive electrode of the capacitor. A voltage at the switch node is alternately switched to (i) a first voltage that is substantially the same as a voltage at the high potential node, and (ii) a second voltage that is lower than the first voltage.

According to the above-described configuration, switching the voltage at the switch node to the first voltage (e.g., high potential) causes the auxiliary power supply to charge the capacitor via the diode and the switch element. On the other hand, when the voltage at the switch node is switched to the second voltage, the discharge of the capacitor can be prevented from being generated by the diode. Specifically, the diode cuts off the current from the capacitor to the auxiliary power supply. Thus, the capacitor functions as an auxiliary power supply.

In the auxiliary power supply circuit according to a second aspect of the present disclosure, the voltage of the auxiliary power supply is smaller than the first voltage.

According to the above-described configuration, there is no concern that the voltage of the auxiliary power supply will damage the switch element by applying an overvoltage.

In the auxiliary power supply circuit according to a third aspect of the present disclosure, the parasitic capacitance of the diode is 1/20 of the electrostatic capacitance of the capacitor or less.

According to the above-described configuration, the voltage drop in the capacitor generated when the voltage at the switch node becomes the second voltage can be reduced to approximately 5% or less.

In the auxiliary power supply circuit according to a fourth aspect of the present disclosure, when a current flows from the switch node to the high potential node via the switch element, a current flows from the positive electrode of the auxiliary power supply to the positive electrode of the capacitor via the diode.

According to the above-described configuration, the current of the switch element is reduced, so that the conduction loss and heat generation of the switch element can be reduced.

A power supply device according to a fifth aspect of the present disclosure includes the auxiliary power supply circuit according to an aspect of the present disclosure.

According to the above-described configuration, the power supply device including the auxiliary power supply at the high potential node can be achieved.

Supplementary Information

An aspect of the present disclosure is not limited to each of the embodiments described above. It is possible to make various modifications within the scope indicated in the claims. An embodiment obtained by appropriately combining technical elements each disclosed in different embodiments falls also within the technical scope of an aspect of the present disclosure. Furthermore, technical elements disclosed in the respective embodiments may be combined to provide a new technical feature.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An auxiliary power supply circuit configured to:
receive power from an auxiliary power supply in which a negative electrode is connected to a switch node; and
supply power to a capacitor in which a negative electrode is connected to a high potential node, the auxiliary power supply circuit comprising:
a switch element connected between the high potential node and the switch node; and
a diode in which an anode is connected to a positive electrode of the auxiliary power supply and a cathode is connected to a positive electrode of the capacitor, wherein
a voltage at the switch node is alternately switched to (i) a first voltage that is substantially the same as a voltage at the high potential node, and (ii) a second voltage that is lower than the first voltage.

2. The auxiliary power supply circuit according to claim 1,
wherein a voltage of the auxiliary power supply is smaller than the first voltage.

3. The auxiliary power supply circuit according to claim 1,
wherein parasitic capacitance of the diode is 1/20 of electrostatic capacitance of the capacitor or less.

4. The auxiliary power supply circuit according to claim 1,
wherein when a current flows from the switch node to the high potential node via the switch element, a current flows from the positive electrode of the auxiliary power supply to the positive electrode of the capacitor via the diode.

5. A power supply device comprising:
the auxiliary power supply circuit according to claim 1.
